(19) United States
(12) Patent Application Publication
(10) Pub. No.: US 2008/0315867 A1
(43) Pub. Date: Dec. 25, 2008

(54) Joint for a Motor Vehicle

(76) Inventors: Joachim Spratte, Osnabruck (DE); Michael Klank, Osnabruck (DE)

Correspondence Address: MCGLEW & TUTTLE, PC, P.O. BOX 9227, SCARBOROUGH STATION, SCARBOROUGH, NY, 10510-9227, US

(21) Appl. No.: 11/994,668

(22) PCT Filed: Jun. 27, 2006
(86) PCT No.: PCT/DE2006/001104

§ 371 Date: Jun. 5, 2008

(30) Foreign Application Priority Data
Jul. 7, 2005 (DE) 10 2005 032 145.3

(51) Int. Cl. G01B 7/30; F16C 11/06

(52) U.S. Cl. 324/207.13; 403/122

(57) ABSTRACT

A joint for a motor vehicle has a joint housing (2), with a pivot pin (5) mounted pivotably in same and with an angle-measuring device, which has a magnet (18) and a magnetic field-sensitive sensor, which cooperates with this magnet and by which the angle (φ) of the pivot pin (5) relative to the joint housing (2) can be determined. The magnet (18) is fastened to the pivot pin (5) and the sensor to the joint housing (2) or the magnet (18) is fastened to the joint housing (2) and the sensor to the pivot pin (5) at least indirectly. The magnetic field-sensitive sensor is formed by an electric coil (17), which has a core (16) consisting of a magnetic material and which is part of an electrical oscillating circuit (15), by which electromagnetic waves (27) can be sent or are sent.

### CROSS REFERENCE TO RELATED APPLICATIONS

This application is a United States National Phase application of International Application PCT/DE 2006/001104 and claims the benefit of priority under 35 U.S.C. § 119 of German Patent Application DE 10 2005 032 145.3 filed Jul. 7, 2005, the entire contents of which are incorporated herein by reference.

### FIELD OF THE INVENTION

The present invention pertains to pertains to a joint for a motor vehicle, with a joint housing, a pivot pin mounted pivotably in same and an angle-measuring device, which has a magnet and a magnetic field-sensitive sensor cooperating with the magnet and by means of which the angle of the pivot pin relative to the joint housing can be determined, wherein the magnet is fastened to the pivot pin and the sensor to the joint housing or the magnet is fastened to the joint housing and the sensor to the pivot pin at least indirectly. The present invention pertains, furthermore, to a motor vehicle and to a measuring set-up with such a joint.

### BACKGROUND OF THE INVENTION

Joints with an angle-measuring device are known; the angle of a pivot pin relative to a joint housing can be measured by means of these devices. The angle information obtained can be used, among other things, for the headlight leveling control of gas discharge lamps in a motor vehicle. The power supply for the angle-measuring device as well as the transmission of the angle information are carried out via plugs and cables at a control device. However, plug-in connections are a chief cause of failures of electronic systems in motor vehicles.

Tire pressure measuring systems have been known to operate via radio. Small radio transmitters with battery are arranged in the tires and a resolver receiver in the wheel case. The drawback is the limited service life of the battery. An oscillating circuit, which is equipped with an piezoelectric resonator and is excited by a transmitter in the wheel case to perform high-frequency oscillations in the GHz range, is used in more recent systems. The pressure measurement is performed capacitively. The change in capacitance due to the pressure detunes the oscillating circuit, so that the oscillating circuit also sends a signal with its intrinsic frequency, besides the exciting frequency. This signal is received and analyzed by the receiver in the wheel case.

### SUMMARY OF THE INVENTION

Based on this state of the art, the basic object of the present invention is to perfect a joint of the type mentioned in the introduction such that the drawbacks associated with plug-in connections can be reduced or avoided.

The joint according to the present invention for a motor vehicle has a joint housing, a pivot pin mounted pivotably in same, and an angle-measuring device, which comprises a magnet and a magnetic field-sensitive sensor cooperating with this [magnet] and by means of which the angle of the pivot pin relative to the joint housing can be determined, the magnet being fastened to the pivot pin and the sensor to the joint housing or the magnet is fastened to the joint housing and the sensor to the pivot pin indirectly or directly. The magnetic field-sensitive sensor is formed by an electric coil, which has a core consisting of a magnetic material and is part of an electric oscillating circuit, by which electromagnetic waves can be sent or are sent.

Instead of a capacitive sensor, as in the conventional tire pressure measuring systems, an inductance, which is formed by an electric coil with a magnetic core, is introduced as a sensor into the oscillating circuit in the joint according to the present invention, and the permeability of the magnetic material is affected by a magnetic field of the magnet, which flows through the core. Since the magnet is fastened to the pivot pin and the sensor to the joint housing or the magnet is fastened to the joint housing and the sensor to the pivot pin, a motion of the pivot pin relative to the joint housing inevitably leads to a motion of the magnet relative to the coil or the oscillating circuit, and the respective fastenings are designed as rigid fastenings. Thus, depending on the angle between the pivot pin and the joint housing, the magnet is located at different distances from and/or in different orientations relative to the magnetic core, so that a magnetic field of varying intensity and/or varying orientation flows through the core, depending on the angle. The permeability of the core thus depends on the angle, so that the inductance of the electric coil and hence also the resonant frequency of the electrical oscillating circuit show a dependence on the angle as well. Due to the angle-dependent variation of the resonant frequency of the electrical oscillating circuit, electromagnetic waves with an angle-dependent frequency, which thus forms a variable characterizing the angle, are sent by the oscillating circuit. The electromagnetic waves sent therefore form an angle signal.

A plug-in cable connection between the angle-measuring device and an analysis means, which is arranged especially outside the joint, can be eliminated in the joint according to the present invention. The analysis unit is to be connected only to a receiver for electromagnetic waves, which receives the electromagnetic waves sent by the electrical oscillating circuit. A wireless connection is thus possible between the angle-measuring device and the analysis unit, so that the drawbacks associated with plug-in connections can be avoided for the transmission of the angle signals sent by the angle-measuring device. The receiver may form a separate assembly unit or be integrated within the analysis means.

The magnetic core or the magnetic material preferably consists of a ferromagnetic material. In particular, the magnetic core is formed from iron or a ferrite.

The magnetic material or the core must not have permanent resulting magnetization without an external magnetic field and, in particular, it must not form a permanent magnet. Yet, a core designed as a permanent magnet is possible. Furthermore, the magnetic core is preferably arranged stationarily in relation to the coil and is preferably wrapped around by the windings of the coil. The electric oscillating circuit is also preferably arranged stationarily in relation to the coil.

The resonant frequency of the electrical oscillating circuit is especially in the high-frequency range, preferably in the GHz range, so that the frequency of the electromagnetic waves sent by the electrical oscillating circuit is also in the high-frequency or GHz range.

The electrical oscillating circuit preferably has at least one capacitor, to which the coil is connected to form an electrical oscillating circuit. As an alternative or in addition, a piezoelectric resonator may, however, also be part of the electrical oscillating circuit, which is connected to the coil in a suitable manner.

The electrical oscillating circuit can be supplied with electric energy from a power source arranged outside or within the joint. For example, a battery may be used as an inner power source. However, since the battery may possibly have to be replaced or removed for recharging, this solution is associated with a rather substantial assembly effort. As an alternative to the inner power source, a motor vehicle battery or a motor vehicle generator (e.g., a vehicle generator) may be used. The connection between the external power source and the electrical oscillating circuit can be embodied in this case via a plug-in cable connection. However, this creates a possibility for failure of the angle-measuring device based on a defective plug-in connection, so that the electrical oscillating circuit is preferably supplied with energy in the form of electromagnetic waves by a transmitter arranged outside the joint. A plug-in connection is not necessary in this case either for the power supply or the transmission of the measured angle signals. The plug-in connections, which are prone to defects, may be eliminated, so that the entire system becomes more reliable. Since no separate battery is needed, the installation space needed and weight can be reduced and the service life of the sensor system or the angle-measuring device can be prolonged.

The change in the permeability of the magnetic core detunes the electrical oscillating circuit, so that the latter also sends a signal (=electromagnetic waves sent by the electrical oscillating circuit) with its intrinsic frequency, besides the exciting frequency (=frequency of the electromagnetic waves sent by the transmitter). This signal can be received and analyzed by the receiver.

The frequency of the electromagnetic waves sent by the transmitter is preferably in the resonance range of the electrical oscillating circuit. In particular, the frequency of the electromagnetic waves sent by the transmitter is equal to a resonant frequency of the electrical oscillating circuit at a defined angle between the pivot pin and the joint housing. This defined angle may equal, e.g., 0° (no deflection between the pivot pin and the joint housing) or correspond to another, e.g., maximum deflection of the pivot pin relative to the joint housing.

Since the resonant frequency of the electrical oscillating circuit is preferably in the high-frequency range, especially in the GHz range, the frequency of the electromagnetic waves sent by the transmitter is preferably also in the high-frequency or GHz range.

The electrical oscillating circuit may have at least one antenna, which is fastened, e.g., in or at the joint housing or is formed by this joint housing or by a part of the joint housing. However, the oscillating circuit is constructed, in particular, such that the antenna is formed by the joint itself, so that a separate antenna can be eliminated.

Since the angle-measuring device is especially integrated completely in the joint, a compact measuring set-up can be obtained, which is protected by the joint housing from external effects. In particular, the angle-measuring device is integrated as an assembly unit having no battery and cable in the joint.

The magnet is preferably designed as a permanent magnet, so that no power source is necessary for generating the magnetic field. Furthermore, the magnet is fastened, in particular, to the pivot pin and the electrical oscillating circuit to the joint housing.

The housing may have an opening, through which the pivot pin extends, the area of the housing located opposite this opening preferably comprising a bottom, on which, e.g., a bearing shell arranged between the joint housing and the pivot pin is supported. The electrical oscillating circuit is preferably arranged in the area of the bottom and is seated, in particular, on a plate or printed circuit board, which is directly fastened to the joint housing by means of a bracket.

The joint is preferably a ball and socket joint, so that the pivot pin has a pin and a joint ball, which is connected to same and in which, e.g., the magnet is seated. The pivot pin or ball pivot is especially additionally rotatable in the joint housing, so that this [pivot pin] is mounted in the housing such that it can be rotated and pivoted via the joint ball.

The present invention pertains, furthermore, to a motor vehicle with a joint according to the present invention, which can be perfected according to all the embodiments mentioned above. The motor vehicle preferably has a vehicle body and a wheel suspension, in which the joint, in particular, is arranged.

The present invention additionally pertains to a measuring set-up for a motor vehicle, which set-up has at least one joint according to the present invention, which can be perfected according to all the embodiments mentioned above. In particular, the measuring set-up also comprises the receiver and/or the transmitter.

The present invention will be described below on the basis of a preferred embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of an embodiment of the ball and socket joint according to the present invention;

FIG. 2 is a schematic view of the ball and socket joint according to FIG. 1 in the deflected state;

FIG. 3 is a schematic circuit diagram of the electrical oscillating circuit of the pivot pin according to FIG. 1;

FIG. 4 is a schematic circuit diagram of a measuring step-up for the ball and socket joint according to FIG. 1;

FIG. 5 is a schematic view of a wheel suspension for a motor vehicle with the ball and socket joint according to FIG. 1; and

FIG. 6 is a sectional view of a variant of the embodiment of the ball and socket joint according to the present invention.

### DESCRIPTION OF THE PREFERRED EMBODIMENTS

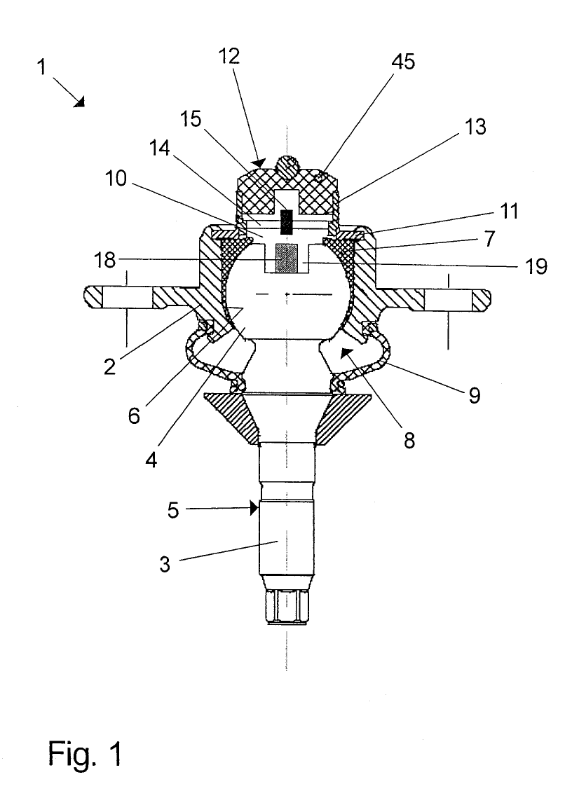

Referring to the drawings in particular, FIG. 1 shows an embodiment of the ball and socket joint 1 according to the present invention, which has a ball and socket joint housing 2 and a ball pivot 5 comprising a pin 3 and a joint ball 4 connected thereto. A bearing shell or ball shell 7, which has a spherical bearing surface 6 and in which the ball pivot 5 with its joint ball 4 is mounted rotatably and pivotably, is arranged in the joint housing 2. The ball and socket joint housing 2 has an opening 8, through which the ball pivot 5 extends. Furthermore, a sealing bellows 9, which extends up to the ball pivot 5 and is sealingly in contact with same, is fastened to the joint housing 2 in the area of the opening 8.

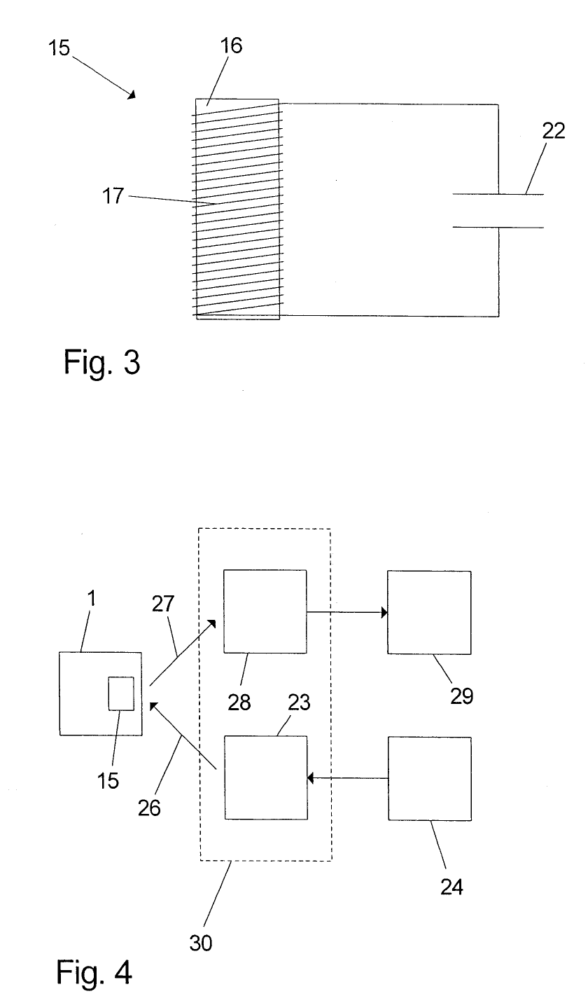

On the side located opposite the opening 8, the joint housing 2 has a bottom 11, which is provided with an opening 10 and which is closed by a cover 12. The cover 12 comprises a ring-shaped bracket 13, which is attached to the joint housing 2 and carries a printed circuit board 14, on which an electrical oscillating circuit 15 with a coil 17 (see FIG. 3) having a magnetic core (see FIG. 3) is fastened. The ring-shaped bracket 13 is closed with a pourable sealing compound on the side of the printed circuit board 14 facing away from the joint ball 4.

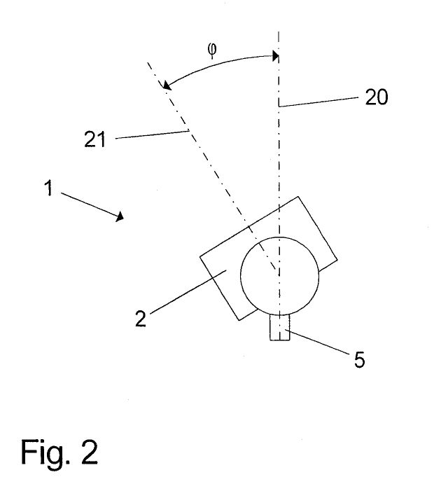

A magnet 18, which cooperates with the coil 17 of the electrical oscillating circuit 15, which coil is fastened to the printed circuit board 14, forms a magnetic field-sensitive sensor and has the core 16, is arranged in the joint ball 4, the electrical oscillating circuit 15 forming, together with the magnet 18, an angle-measuring device, by means of which a twisting and/or pivoting angle φ (see FIG. 2) of the ball pivot 5 relative to the joint housing 2 can be determined. The magnet 18 is seated here in a recess 19 provided in the joint ball 4.

FIG. 2 schematically shows the angle φ between the longitudinal axis 20 of the ball pivot 5 and the longitudinal axis 21 of the joint housing 2. As an alternative or in addition, it is possible that the measured angle φ represents the twisting of the ball pivot 5 in relation of the joint housing 2 about its longitudinal axis 20.

FIG. 3 shows a schematic circuit diagram of the electrical oscillating circuit 15, in which the coil 17 provided with the magnetic core 16 is connected to a capacitor 22 to form the oscillating circuit 15.

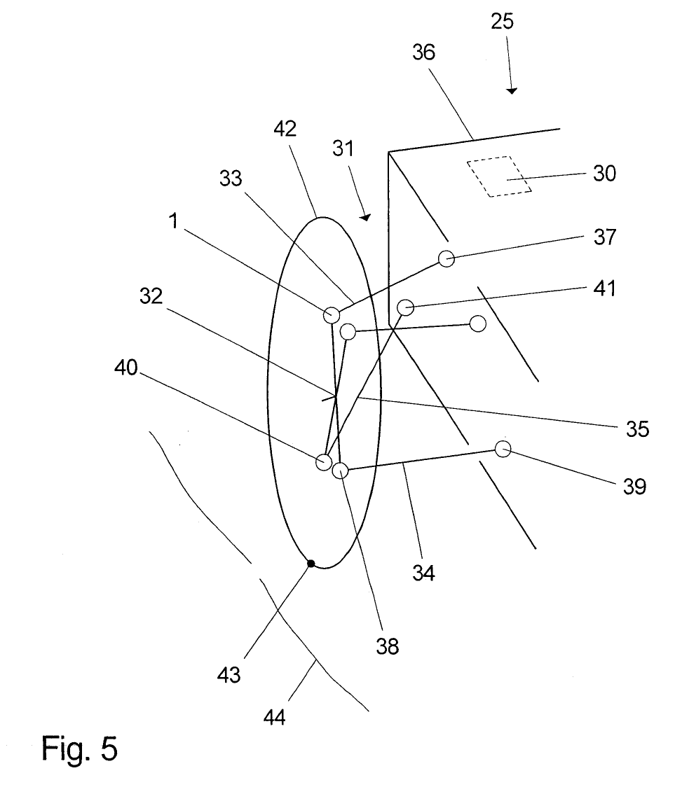

FIG. 4 schematically shows a measuring set-up, in which the oscillating circuit 15 of the ball and socket joint 1 is supplied with energy via a transmitter 23. The transmitter 23 is connected to the general power supply 24 of a motor vehicle 25 (see FIG. 5) and sends electromagnetic waves 26, which are received by the oscillating circuit 15, as a result of which this oscillating circuit 15 is supplied with energy and is excited to oscillate. The electrical oscillating circuit 15 in turn now sends electromagnetic waves 27, which are received by a receiver 28. The receiver 28 is connected to an analysis means 29, which processes the signals received by the receiver 28 and actuates, e.g., a headlight leveling control for a motor vehicle headlight. The analysis means 29 may be designed as an analog or digital assembly unit or formed by a digital computer. Furthermore, the transmitter 23 and the receiver 28 may be united into a transmitter-receiver means 30, in which the analysis means 29 may be integrated as well.

FIG. 5 shows a schematic view of a wheel suspension 31, in which a wheel carrier 32 is connected to a vehicle body 36 of the motor vehicle 25, which is shown partially, via an upper suspension arm 33, a lower suspension arm 34 and a radius arm 35. The upper suspension arm 33 is connected to the wheel carrier 32 via the ball and socket joint 1 according to the present invention and to the vehicle body 36 via a joint or elastomer bearing 37. The lower suspension arm 34 is connected to the wheel carrier 32 via a ball and socket joint 38 and to the vehicle body 36 via an elastomer bearing 39. Furthermore, the radius arm 35 is connected to the wheel carrier 32 via a ball and socket joint 40 and to the vehicle body 36 via an elastomer bearing 41. A tire or a wheel 42, which is in contact with a road surface 44, shown schematically, in a wheel contact point 43, is mounted rotatably on the wheel carrier 32. Furthermore, the transmitting-receiving means 30 is arranged in the vehicle body 36 in the proximity in space of the ball and socket joint 1 or the wheel suspension 31.

Consequently, only the ball and socket joint 1 forms a joint according to the present invention in the wheel suspension 31 being shown. In addition or as an alternative, it is possible that joints according to the present invention are formed by one or more of the other joints or bearings as well.

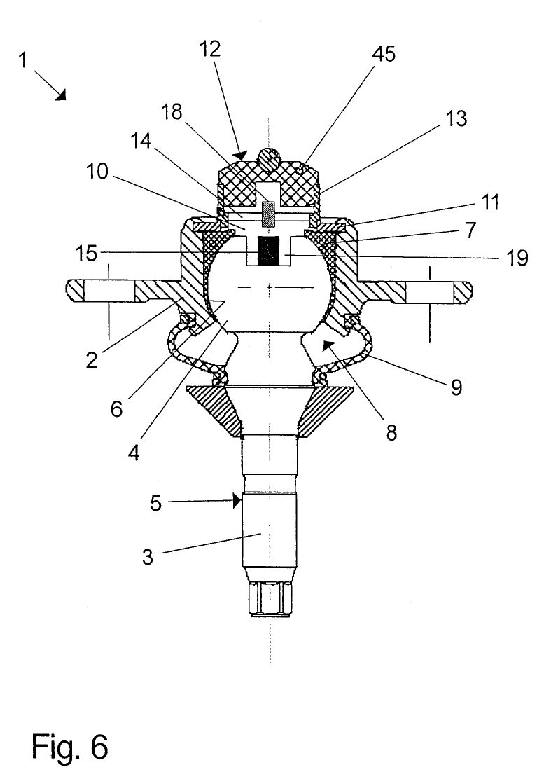

FIG. 6 shows a variant of the ball and socket joint shown in FIG. 1, in which identical or similar features are designated by the same reference numbers as in FIG. 1. The magnet 18 is seated on the printed circuit board 14 and is thus fastened to the ball and socket joint housing 2 in the ball and socket joint 1 according to FIG. 6, whereas the oscillating circuit 15 with the coil having the core is fastened to the joint ball 4 of the ball pivot 5. Aside from this deviation, the variant according to FIG. 6 corresponds to the ball and socket joint according to FIG. 1.

While specific embodiments of the invention have been shown and described in detail to illustrate the application of the principles of the invention, it will be understood that the invention may be embodied otherwise without departing from such principles.

1-8. (canceled)

9. A joint for a motor vehicle, the joint comprising:
a joint housing;
a pivot pin mounted pivotably in said joint housing;
an angle-measuring device including a magnet and a magnetic field-sensitive sensor cooperating with said magnet, said angle-measuring device for determining an angle of said pivot pin relative to said joint housing, said magnet being fastened to or associated with said pivot pin and said sensor being fastened to or associated with said joint housing, said magnetic field-sensitive sensor being formed by a electric coil and a core of a magnetic material and being part of an electrical oscillating circuit, by which electromagnetic waves are sent.

10. A joint in accordance with claim 9, further comprising a receiver arranged outside said joint wherein said electromagnetic waves are received by said receiver.

11. A joint in accordance with claim 9, wherein said magnetic core is formed of iron or a ferrite.

12. A joint in accordance with claim 9, further comprising a transmitter arranged outside said joint wherein said electrical oscillating circuit is supplied with energy in the form of electromagnetic waves by a transmitter arranged outside said joint.

13. A joint in accordance with claim 9, wherein said magnet and said electrical oscillating circuit with said coil having said core are integrated in the joint.

14. A joint in accordance with claim 9, wherein the joint is a ball and socket joint and said pivot pin has a pin portion and a joint ball connected to said pin portion, said magnet being seated in said joint ball.

15. A motor vehicle comprising:
a vehicle body;
a wheel suspension; and
a joint arranged in said wheel suspension, said joint comprising a joint housing, a pivot pin mounted pivotably in said joint housing and an angle-measuring means including a magnet and a magnetic field-sensitive sensor cooperating with said magnet, said angle-measuring means for determining an angle of said pivot pin relative to said joint housing, said magnet being fastened to or associated with said pivot pin and said sensor being fastened to or associated with said joint housing, said magnetic field-sensitive sensor being formed by a electric coil and a core of a magnetic material and being part of an electrical oscillating circuit, by which electromagnetic waves are sent.

16. A motor vehicle in accordance with claim 15, further comprising a receiver arranged outside said joint wherein said electromagnetic waves are received by said receiver.

17. A motor vehicle in accordance with claim 15, wherein said magnetic core is formed of iron or a ferrite.

18. A motor vehicle in accordance with claim 15, further comprising a transmitter arranged outside said joint wherein said electrical oscillating circuit is supplied with energy in the form of electromagnetic waves by a transmitter arranged outside said joint.

19. A motor vehicle in accordance with claim 15, wherein said magnet and said electrical oscillating circuit with said coil having said core are integrated in the joint.

20. A motor vehicle in accordance with claim 15, wherein the joint is a ball and socket joint and said pivot pin has a pin portion and a joint ball connected to said pin portion, said magnet being seated in said joint ball.

21. A motor vehicle measuring system comprising:
a joint comprising a joint housing, a pivot pin mounted pivotably in said joint housing and an angle-measuring means including a magnet and a magnetic field-sensitive sensor cooperating with said magnet, said angle-measuring means for determining an angle of said pivot pin relative to said joint housing, said magnet being fastened to or associated with said pivot pin and said sensor being fastened to or associated with said joint housing, said magnetic field-sensitive sensor being formed by a electric coil and a core of a magnetic material and being part of an electrical oscillating circuit, by which electromagnetic waves are sent;
a receiver, wherein electromagnetic waves sent by said oscillating circuit are received by said receiver.

22. A motor vehicle measuring system in accordance with claim 21, wherein said receiver is arranged outside said joint wherein said electromagnetic waves are received by said receiver at a location outside said joint.

23. A motor vehicle measuring system in accordance with claim 21, wherein said magnetic core is formed of iron or a ferrite.

24. A motor vehicle measuring system in accordance with claim 22, further comprising a transmitter arranged outside said joint wherein said electrical oscillating circuit is supplied with energy in the form of electromagnetic waves by a transmitter arranged outside said joint.

25. A motor vehicle measuring system in accordance with claim 21, wherein said magnet and said electrical oscillating circuit with said coil having said core are integrated in the joint.

26. A motor vehicle measuring system in accordance with claim 21, wherein the joint is a ball and socket joint and said pivot pin has a pin portion and a joint ball connected to said pin portion, said magnet being seated in said joint ball.
